(19) United States
(12) Patent Application Publication
(10) Pub. No.: US 2017/0132546 A1
(43) Pub. Date: May 11, 2017

(54) COMPLIANCE PORTFOLIO PRIORITIZATION SYSTEMS AND METHODS

(71) Applicant: Tata Consultancy Services Limited, Mumbai (IN)

(72) Inventors: Kelly Denise RAY, Krugerville, TX (US); Timothy OXBOROUGH-POWELL, New York, NY (US)

(73) Assignee: Tata Consultancy Services Limited, Mumbai (IN)

(21) Appl. No.: 15/349,620

(22) Filed: Nov. 11, 2016

Related U.S. Application Data
(60) Provisional application No. 62/253,866, filed on Nov. 11, 2015.

(51) Int. Cl. G06Q 10/06; G06Q 10/10

(52) U.S. Cl. CPC G06Q 10/06313; G06Q 10/103

(57) ABSTRACT

This disclosure relates generally to continuous project portfolio ranking, and more particularly to a continuous compliance portfolio prioritization methodology. In one embodiment, a method includes assigning relative weight to each of a set of criteria for rating projects in a portfolio of projects. The set of criteria includes business alignment, project risk management impact, governance, risk, and compliance (GRC) management impact, and value (i.e., via return on investment or other unclaimed methodology). The method also includes assigning a numerical scoring value to each project in the portfolio of projects for each of business alignment sub-criteria, project risk management sub-criteria, GRC risk management impacts sub-criteria, and the value criteria. The method also includes assigning a rank to each project in the portfolio of projects based on summary rating scores for each project.

### PRIORITY CLAIM

This U.S. patent application claims priority under 35 U.S.C. §119 to U.S. No. 62/253,866, filed on Nov. 11, 2015. The entire contents of the aforementioned application are incorporated herein by reference.

### TECHNICAL FIELD

This disclosure relates generally to project portfolio ranking, and more particularly to continuous compliance portfolio prioritization methods and systems.

### BACKGROUND

Organizations typically undertake a variety of compliance projects in an effort to place the organization in compliance with a variety of legal mandates, industry standards, regulatory rules and guidelines and/or self-imposed contractual and public commitments. Compliance obligations may emanate from various levels of governmental and/or private authorities whose individual scope of authority may span various levels of geographies, entity types, facility types, and products/services. Beyond the authoritative body's general scope of authority, particular obligations may reach extra-territorially, creating the need for action plans spanning the organization's operations around the globe.

In addition to performing ongoing compliance programs (e.g., established ongoing business as usual activities), during the course of doing business over a given time period (e.g., a budget year or quarter, etc.), an organization may be faced with multiple changes to compliance obligations emanating from changes in the legal climate, changes to their organizational profile (e.g., scope or location of operations, products/services mix and assets), or undertaken system improvements resulting in a need to address multiple compliance projects simultaneously. Faced with fixed dates for compliance enforcement or committed dates to stakeholders and limited budgets for each fiscal period, organizations are not always able to undertake with equal rigor work streams for all desired compliance projects within the same fiscal period.

### SUMMARY

Embodiments of the present disclosure present technological improvements as solutions to one or more of the above-mentioned technical problems recognized by the inventors in conventional systems. For example, in one embodiment, a processor-implemented method for ranking projects in a portfolio of projects is provided. The method includes assigning relative weights to a set of criteria and a set of sub-criteria associated with the set of criteria for rating a plurality of projects in the portfolio of projects, via one or more hardware processors. Further, the method includes, assigning numerical scoring values to a plurality of guideline scoring ranges for each of the set of criteria and the set of sub-criteria for prioritizing a plurality of projects, via the one or more hardware processors. Further, the method includes assigning a numerical scoring value to each of the plurality of projects for each of the set of sub-criteria, via the one or more hardware processors. Furthermore, the method includes aggregating the numerical scoring values for each project in the portfolio of projects across the set of sub-criteria to obtain a summary rating score for each project, via the one or more hardware processors. Moreover, the method includes assigning a rank to each of the plurality of projects based on the summary rating scores for each project, via the one or more hardware processors. Also, the method includes adapting the ranks of the plurality of projects based on a project data associated with the plurality of projects, via the one or more hardware processors, the project data indicative of project dependencies and pre-requisites. In addition, the method includes incrementally aggregating capital and operating costs of each project in an order of descending ranks until the aggregated costs of the plurality of projects are accommodated by an available project funding in an applicable fiscal period, via the one or more hardware processors.

In another embodiment, a system for ranking projects in a portfolio of projects is provided. The system includes one or more memories; and one or more hardware processors. The one or more memories are coupled to the one or more hardware processors. The one or more hardware processors are capable of executing programmed instructions stored in the one or more memories to assign relative weights to a set of criteria and a set of sub-criteria associated with the set of criteria for rating a plurality of projects in the portfolio of projects. Further, the one or more hardware processors executes programmed instructions to assign numerical scoring values to a plurality of guideline scoring ranges for each of the set of criteria and the set of sub-criteria for prioritizing a plurality of projects, via the one or more hardware processors. Further, the one or more hardware processors executes programmed instructions to assign a numerical scoring value to each of the plurality of projects for each of the set of sub-criteria, via the one or more hardware processors. Furthermore, the one or more hardware processors executes programmed instructions to aggregate the numerical scoring values for each project in the portfolio of projects across the set of sub-criteria to obtain a summary rating score for each project. Also, the one or more hardware processors executes programmed instructions to assign a rank to each of the plurality of projects based on the summary rating scores for each project, via the one or more hardware processors. In addition, the one or more hardware processors executes programmed instructions to adapt the ranks of the plurality of projects based on a project data associated with the plurality of projects, the project data indicative of project dependencies and pre-requisites. Also, the one or more hardware processors executes programmed instructions to incrementally aggregate capital and operating costs of each project in an order of descending ranks until the aggregated costs of the plurality of projects are accommodated by an available project funding in an applicable fiscal period.

In yet another embodiment, a non-transitory computer-readable medium having embodied thereon a computer program for executing a method for ranking projects in a portfolio of projects is provided. The method includes assigning relative weights to a set of criteria and a set of sub-criteria associated with the set of criteria for rating a plurality of projects in the portfolio of projects. Further, the method includes, assigning numerical scoring values to a plurality of guideline scoring ranges for each of the set of criteria and the set of sub-criteria for prioritizing a plurality of projects. Further, the method includes assigning a numerical scoring value to each of the plurality of projects for each of the set of sub-criteria. Furthermore, the method includes aggregating the numerical scoring values for each project in the portfolio of projects across the set of sub-criteria to obtain a summary rating score for each project. Moreover, the method includes assigning a rank to each of the plurality of projects based on the summary rating scores for each project. Also, the method includes adapting the ranks of the plurality of projects based on project data associated with the plurality of projects, the project data being indicative of project dependencies and pre-requisites. In addition, the method includes incrementally aggregating capital and operating costs of each project in an order of descending ranks until the aggregated costs of the plurality of projects are accommodated by an available project funding in an applicable fiscal period.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a network implementation for ranking projects in a portfolio of projects according to some embodiments of the present disclosure.

FIG. 2 a block diagram of a system for ranking projects in a portfolio of projects, in accordance with an embodiment of the present disclosure.

FIG. 3 illustrates a flow diagram of a method for ranking projects in a portfolio of projects, in accordance with some embodiments of the present disclosure.

FIG. 4 illustrates an exemplary output in a tabular format listing a portfolio of projects for prioritization according to some embodiments of the present disclosure.

FIG. 5 illustrates an exemplary method for determining a score for sub-alignment criteria in accordance with some embodiments of the present disclosure.

FIG. 6 illustrates a multi-faceted decision framework for determining the score for the sub-alignment criteria in accordance with the method of FIG. 5 according to some embodiments of the present disclosure.

FIG. 7 illustrates an exemplar set of criteria for assigning an alignment to strategy score in the table of FIG. 6 in accordance with some embodiments of the present disclosure.

FIG. 8 illustrates an exemplar set of criteria for assigning an alignment to values score in the table of FIG. 6 in accordance with some embodiments of the present disclosure.

FIG. 9 illustrates an exemplar set of criteria to be generated algorithmically from the aggregation and analysis of reference data across multiple individual work streams within the project for assigning a project change management rating in accordance with some embodiments of the present disclosure.

FIG. 10 illustrates an exemplar set of criteria for assigning a project readiness rating in accordance with some embodiments of the present disclosure.

FIG. 11 illustrates an exemplar set of criteria for assigning a health and safety risk rating in accordance with some embodiments of the present disclosure.

FIG. 12 illustrates an exemplar set of criteria for assigning a financial risk rating in accordance with some embodiments of the present disclosure.

FIG. 13 illustrates an exemplar set of criteria for assigning a reputational risk rating in accordance with some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

Typically, compliance dates for various projects pertaining to an organization are fixed and budgets are limited, meaning thereby that the organizations may not always be able to accommodate all compliance projects during a given budget period. Accordingly, organizations may need to prioritize the allocation of resources against the compliance projects within their portfolio in a “risk intelligent” way that protects the organization and its stakeholders from the most significant risks first.

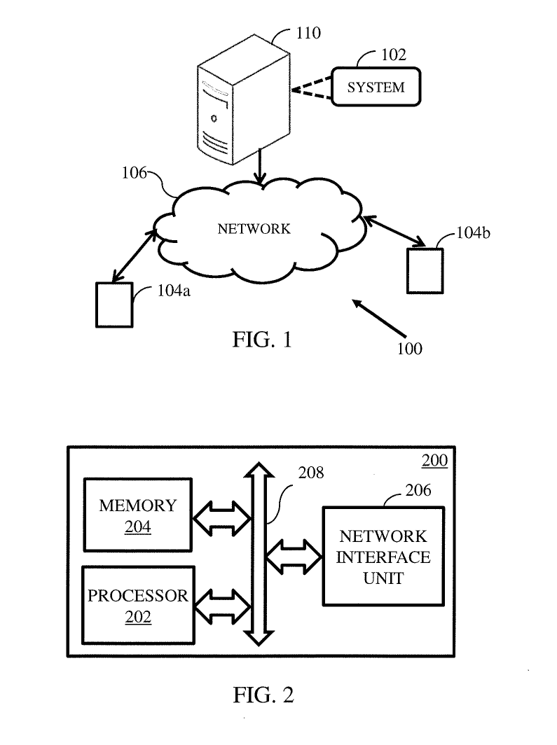

Various embodiments of the present disclosure disclose methods and systems for continuous compliance portfolio prioritization by taking into consideration critical elements that are relevant to such projects. For example, the disclosed method facilitates the continuous realignment of the finances being allocated to the projects and programs, particularly regulatory compliance projects and programs, in a manner that minimizes the risk of non-compliance whether severity of or likelihood of non-compliance as those risks continually fluctuate based on a variety of triggers of change. FIG. 1 illustrates an example network implementation of a system for continuous compliance portfolio prioritization.

Referring now to FIG. 1, a network implementation 100 of system 102 for continuous compliance portfolio prioritization is illustrated, in accordance with an embodiment of the present subject matter. The network implementation 100 is shown to include a system 102, user devices such as user devices 104-1, 104-2 . . . 104-N, and a communication network 106 for facilitating communication between the system 102 and the user devices 104-1, 104-2 . . . 104-N.

The system 102 facilitates in defining a set of criteria used in rating each individual project within a portfolio of projects in an organization, and defining guidelines by which each criteria is rated against numeric values. Further, the system attributes a relative weight to each individual criterion (based on the total available points) to determine an absolute score for each project. Additionally, the system 102 aggregates scores across the criteria to determine a summary rating score. The projects are rank-ordered based on their ratings and dependencies. Upon ranking and ordering, the budgeted costs of each of the projects is compared to the budget cap for the portfolio for each budget period to determine which projects remain active in the current period and which should be deferred to a subsequent period or eliminated from the portfolio because they are superseded by projects triggered by additional change. Based on the budgeted costs of the projects and available budget, the projects may be reprioritized for pursuit.

Herein, although the present subject matter is explained considering that the system 102 is implemented for continuous compliance portfolio prioritization, it may be understood that the system 102 is not restricted to any particular machine or environment. The system 102 may be implemented in a variety of computing systems, such as a laptop computer, a desktop computer, a notebook, a workstation, a mainframe computer, a server, a network server, and the like.

The devices 104 are communicatively coupled to the system 102 through a network 106, and may be capable of transmitting the signals to the system 102. In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

In an embodiment, the system 102 may be embodied in a computing device 110. Examples of the computing device 110 may include, but are not limited to, a desktop personal computer (PC), a notebook, a laptop, a portable computer, a smart phone, a tablet, and the like. An example implementation of the system 102 for continuous compliance portfolio prioritization is described further with reference to FIG. 2.

FIG. 2 a block diagram of a system 200 for ranking projects in a portfolio of projects, in accordance with an embodiment of the present disclosure. In an example embodiment, the system 200 may be embodied in, or is in direct communication with a computing device, for example the computing device 110 (FIG. 1). The system 200 includes or is otherwise in communication with one or more hardware processors such as a processor 202, one or more memories such as a memory 204, and a network interface unit such as a network interface unit 206. In an embodiment, the processor 202, memory 204, and the network interface unit 206 may be coupled by a system bus such as a system bus 208 or a similar mechanism.

The processor 202 may include circuitry implementing, among others, audio and logic functions associated with the communication. For example, the processor 202 may include, but are not limited to, one or more digital signal processors (DSPs), one or more microprocessor, one or more special-purpose computer chips, one or more field-programmable gate arrays (FPGAs), one or more application-specific integrated circuits (ASICs), one or more computer(s), various analog to digital converters, digital to analog converters, and/or other support circuits. The processor 202 thus may also include the functionality to encode messages and/or data or information. The processor 202 may include, among other things, a clock, an arithmetic logic unit (ALU) and logic gates configured to support operation of the processor 202. Further, the processor 202 may include functionality to execute one or more software programs, which may be stored in the memory 204 or otherwise accessible to the processor 202.

The one or more memories such as a memory 204, may store any number of pieces of information, and data, used by the system to implement the functions of the system. The memory 204 may include for example, volatile memory and/or non-volatile memory. Examples of volatile memory may include, but are not limited to volatile random access memory (RAM). The non-volatile memory may additionally or alternatively comprise an electrically erasable programmable read only memory (EEPROM), flash memory, hard drive, or the like. Some examples of the volatile memory includes, but are not limited to, random access memory, dynamic random access memory, static random access memory, and the like. Some example of the non-volatile memory includes, but are not limited to, hard disks, magnetic tapes, optical disks, programmable read only memory, erasable programmable read only memory, electrically erasable programmable read only memory, flash memory, and the like. The memory 204 may be configured to store information, data, applications, instructions or the like for enabling the system 200 to carry out various functions in accordance with various example embodiments. Additionally or alternatively, the memory 204 may be configured to store instructions which when executed by the processor 202 causes the system 200 to behave in a manner as described in various embodiments.

The network interface unit 206 is configured to facilitate communication between the sensing devices (such as the SPO2 device and the GSR device) and the computing device 110. The network interface unit 206 may be in form of a wireless connection or a wired connection. Examples of wireless network interface unit 206 may include, but are not limited to, IEEE 802.11 (Wi-Fi), BLUETOOTH®, or a wide-area wireless connection. Example of wired network interface element 206 includes, but is not limited to Ethernet.

The portfolio of projects necessarily includes multiple projects, some of the projects may be ongoing (like infrastructure maintenance, mandated data conversions or data refreshes, business as usual enhancements or operational efficiency driven changes) and some may be proposed projects based upon compliance or business requirements change triggers. An evaluation of the entire portfolio of projects against available budgets may provide insights on residual risks that exceed enterprise tolerances. A prioritized portfolio or prioritization of projects in the portfolio, may facilitate deciding upon acceptable risks using the budget to be allocated for each of the projects as a proxy for risk mitigation. Additional projects identified during a timeframe, for example, during a year may be prioritized with the same methodology and inserted into the portfolio on a continuous basis, analyzed, and potentially displace or defer existing projects. The system 200 facilitates intelligently ranking a portfolio of projects, thereby enabling prioritization of projects for said portfolio.

The spending on the projects may be categorized into various categories as per the application area of the portfolio. For instance, for governance, risk and compliance (GRC) portfolio, the spending on the project portfolio may be classified into programs and event-related initiatives. ‘Programs’ may refer to ongoing activities with a persistent governance structure typically aligned to a single risk or legal subject area. ‘Event-related Initiatives’ may refer to activities to be undertaken in response to an event-related trigger, which may include the strategic and annual planning processes. ‘Initiatives’ may refer to one or more projects with each project comprising multiple work streams. Each work stream is a singular control, artifact or asset requiring creation, change, or decommissioning.

In an example embodiment, the portfolio of projects for prioritization may include compliance projects related to placing an organization in compliance with rules or regulations regarding topics such as privacy and harassment, “Project X” representing a strategic initiative introducing a new products or service into a new geographic market, and “Risk Reporting FMK” representing a systemic improvement project for enhancing the risk reporting framework. An example of the portfolio of projects is described further with reference to FIG. 4. Herein, it will be noted that the portfolio having only six projects is considered for the sake of brevity of description and ease of understanding, however, in alternate embodiments, the disclosed system 200 may be capable of applying to ranking to a variety of types of suitable projects, not limited to the examples shown and described herein and not limited to the volume shown in the figure.

The system 200 may be caused to assign a point scale to each of a set of criteria for rating projects in a portfolio of projects. For example, a set of criteria to which a point scale is assigned includes business alignment, project risk management impact, governance, risk, and compliance (GRC) risk management impacts, and value (ROI). In an embodiment, the set of sub-criteria associated with the plurality of criteria includes, for example, (a) sub-criteria ‘alignment to strategies and values’ associated with the criteria ‘alignment’, (b) sub-criteria ‘scope’, ‘change management’, ‘complexity’, and ‘readiness’ associated with the criteria ‘project risk management’ sub-criteria; and (c) sub-criteria ‘health and safety’, ‘financial’, ‘reputational’, and ‘compliance’ associated with the criteria ‘GRC risk management’.

Further, the system 200 may be caused to assign a point scale to each of a set of sub-criteria for each criterion. For instance, the set of sub-criteria to which a point scale is assigned may be the sub-criteria for the business alignment criterion, namely, alignment to strategy and alignment to values. In an embodiment, the system 200 may be caused to visually present guidance to human users on the application of the point scale to each set of criteria and sub-criteria or may assign the points based on the execution of analytical algorithms drawing from pre-configured business rules utilizing reference data maintained in other systems.

The system 200 is caused to assign relative weight to each of a set of criteria for rating projects in a portfolio of projects. The relative weight may be assigned by an application of percentages. Alternatively, the relative weight may be assigned by point allocation solely. For instance, various criteria such as business alignment, project risk management impact, GRC risk management impacts, and value (ROI) may be assigned each a fixed number of points. The relationship of the points allotted for a single criterion to the total number of points represents the relative weight of each criterion. Alternatively, each criterion may be allotted a relative weight in terms of percentage such that the total weight assigned to all the criteria may be equal to 100 percent and, in combination with the individual point scale for the criterion results in an absolute weight for each criterion. The relative weight percentages define a relative weight of each of the criterion in determining the ranking of the portfolio of projects. In some embodiments, the system 200 may specifically anticipate that the system tools would enable the configuration of the weighting to match the desires of the organizational user of the system. For example, a company may have six key strategies, including expand geographic footprint by 25% via acquisitions, increase profitability by 8%, acquire top 100 best places to work ranking, reduce total operating costs by 5%, and emerge out of heightened regulator scrutiny from prior year's consent order. The business may represent that not all of these strategies are of equal importance (for example each having an equal point maximum or each having equal weight percentages) effectively ranking the strategies by assigning different weight percentages or different total maximum point values to each strategy. Similarly, a business may decide that the Alignment to Strategy criteria is more important than the Alignment to Values criteria, and, thus, assign a lower value to the Alignment to Values score using a lower percentage or lower number of maximum available points.

The system 200 may be caused to assign relative sub-weights to each of a set of sub-criteria for each criterion. The total of the sub-weight percentages for each criterion is set to equal 100%. For example, the business alignment criterion may have sub-criteria for alignment to strategy and alignment to values that may be assigned sub-weight percentages. Similarly, the project risk management criterion has sub-criteria for scope, change management, complexity, and readiness that are each assigned a sub-weight percentage. A detailed example of assigning sub-weight percentages for each criterion is described further with reference to FIG. 4.

In an embodiment, the system 200 may be caused to translate the relative weights into absolute weight percentages for each sub-criteria based on the assigned relative weight and sub-weight percentages. The translation of the relative weights into absolute weight percentages facilitates the use of weights in algorithmic calculations.

The system 200 is caused to assign a numerical scoring value to each project for each sub-criteria based on guideline scoring ranges for each sub-criteria. In an embodiment, the scoring ranges corresponding to each of the sub-criteria may be predefined based on a manual input from a user, calculations across acquired meta-data passed into the system and/or meta-data associated with the individual work streams that comprise the multiple activities within a project. Based on the scoring guidelines, a numerical scoring value is assigned to each project for each sub-criteria.

The system 200 is caused to aggregate the scores for each project across the sub-criteria to determine a summary rating score for each project. Further, the system 200 is caused to assign a rank to each project based on the summary rating score. The programs are then ranked with the highest scoring program being assigned the highest ranking and the lowest scoring program being assigned the lowest ranking.

It should be noted that scoring may be performed via a variety of suitable methods, depending on implementation-specific considerations. For example, in some embodiments, scoring may be provided via human input. In other embodiments, scoring may be provided via automated calculations based on the business rules in the criteria guidelines for ingested risk-related meta-data, or automated calculations based on the business rules in the criteria guidelines for meta-data maintained at the work stream level within each project.

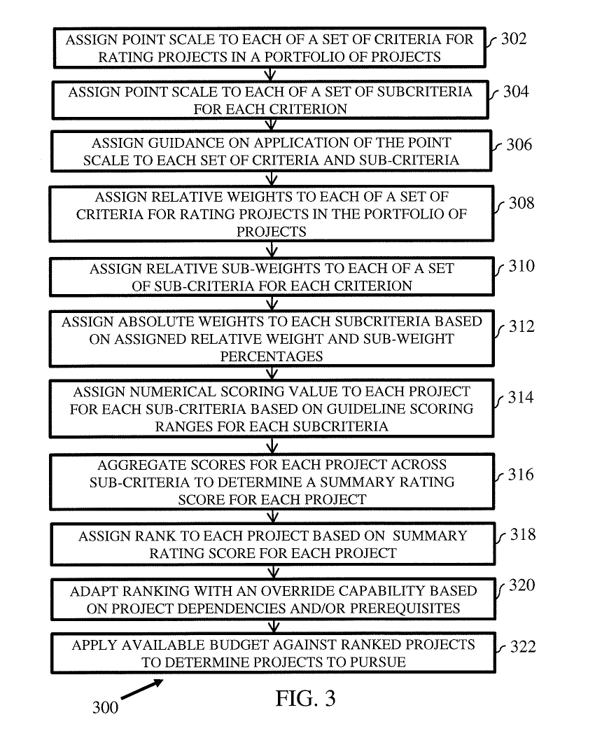

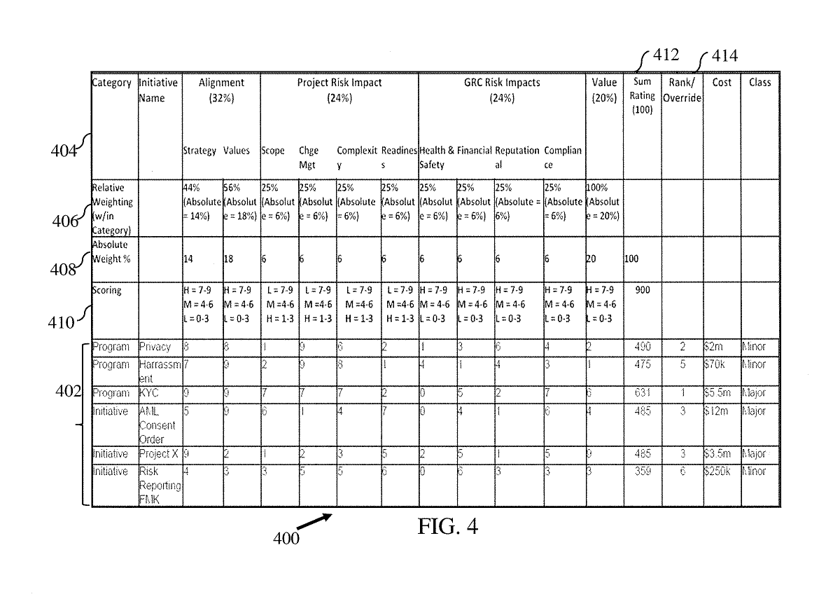

The system 200 may be caused to adapt the assigned rank of each of the projects with an override capability based on project dependencies and/or prerequisites. For example, in some embodiments, the system may adjust the assigned ranking, for instance, because a given project depends on the completion of another project not yet completed. The system 200 may further be caused to apply available budget against the ranked projects to determine which projects to pursue. For example, in accordance, the projects may be pursued in the order from highest to lowest ranked until the budget for a given time period (e.g., a given fiscal year or quarter) is exhausted. In other embodiments, a costly but higher ranked project may be put on hold to complete a larger number of lower ranked projects. An example method for ranking a portfolio of projects is described further with reference to FIG. 3.

FIG. 3 illustrates an exemplary method 300 for ranking a portfolio of projects in accordance with disclosed embodiments. The method 300 may be described in the general context of computer executable instructions. Generally, computer executable instructions can include routines, programs, objects, components, data structures, procedures, modules, functions, etc., that perform particular functions or implement particular abstract data types. The method 300 may also be practiced in a distributed computing environment where functions are performed by remote processing devices that are linked through a communication network. The order in which the method 300 is described is not intended to be construed as a limitation, and any number of the described method blocks can be combined in any order to implement the method 300, or an alternative method. Furthermore, the method 300 can be implemented in any suitable hardware, software, firmware, or combination thereof. In an embodiment, the method 300 depicted in the flow chart may be executed by a system, for example, the system 200 of FIG. 2. In an example embodiment, the system 200 may be embodied in a computing device, for example, the computing device 110 (FIG. 1).

The method 300 of FIG. 3 will be explained in more detail below with reference to a prioritization table 400 listing a portfolio of six projects 402 for prioritization, as illustrated in FIG. 4. In the illustrated embodiment, the portfolio of projects 402 includes compliance projects related to placing an organization in compliance with rules or regulations regarding topics such as privacy and harassment, “Project X” representing a strategic initiative introducing a new products or service into a new geographic market, and “Risk Reporting FMK” representing a systemic improvement project for enhancing the risk reporting framework. However, in other embodiments, the method 300 may be applied to ranking a variety of types of suitable projects, not limited to the examples shown and described herein. At step 302, the method 300 may include assigning a point scale to each of a set of criteria for rating projects in a portfolio of projects. For example, in table 400 (FIG. 4), the set of criteria to which a point scale is assigned includes business alignment, project risk management impact, governance, risk, and compliance (GRC) risk management impacts, and value (ROI).

Further, at step 304, the method 300 includes assigning a point scale to each of a set of sub-criteria for each criterion. For example, the sub-criteria business alignment criterion to which a point scale is assigned may be, alignment to strategy and alignment to values. Further, the method 300 may include assigning guidance on the application of the point scale to each set of criteria and sub-criteria, at step 306.

At step 308, the method 300 includes assigning relative weight to each of a set of criteria for rating projects in a portfolio of projects, shown as the application of percentages but could be accomplished by point allocation solely. For example, in table 400, the set of criteria includes business alignment, project risk management impact, GRC risk management impacts, and value (ROI). Each of these criterion is assigned a relative weight percentage, as shown in row 404 of the table 400, with the total weight percentage being equal to 100%. For example, business alignment, project risk management impacts, GRC risk management impacts, and value (ROI) are assigned relative weight percentages of 32%, 24%, 24%, and 20%, respectively. The relative weight percentages define a relative weight of each of the criterion in determining the ranking of the portfolio of projects 402. For example, alignment is weighted more heavily at 32% than any of the other criterion and, thus, has a larger impact on the project ranking than any of the other criterion. In some embodiments, the method 300 may specifically anticipate that the system tools would enable the configuration of the weighting to match the desires of the organizational user of the system.

At step 310, the method 300 further includes assigning relative sub-weights (e.g., shown here as percentages) to each of a set of sub-criteria for each criterion. The total of the sub-weight percentages for each criterion is set to equal 100%. For example, as shown in row 406 of table 400, the business alignment criterion has sub-criteria for alignment to strategy and alignment to values that are assigned sub-weight percentages of 44% and 56%, respectively. Similarly, the project risk management criterion has sub-criteria for scope, change management, complexity, and readiness that are each assigned a sub-weight percentage of 25%. Likewise, the GRC risk management criterion has sub-criteria for health and safety, financial, reputational, and compliance that are each assigned a sub-weight percentage of 25%.

For ease of use in algorithmic calculations, in some embodiments, the method 300 further translates the relative weights into absolute weight percentages for each sub-criteria based on the assigned relative weight and sub-weight percentages, as in step 312. For example, in row 408 of table 400, each sub-weight percentage is related back to the relative weight percentages assigned to a given criterion. For further example, for the strategy portion of the alignment criterion, the 44% sub-weight percentage is converted to an absolute percentage of 14% based on the assigned 32% for the business alignment criterion.

At step 314, the method 300 further includes assigning a numerical scoring value to each project for each sub-criteria based on guideline scoring ranges for each sub-criteria. For example, row 410 of table 400 defines predetermined scoring ranges for each of the sub-criteria, such as assigning a 7-9 for a high rating, a 4-6 for a medium rating, and a 0-3 or 1-3 for a low rating. In some embodiments, the guideline scoring ranges may be predefined based on a manual input from a user, calculations across acquired meta-data passed into the system and/or meta-data associated with the individual work streams that comprise the multiple activities within the project. Based on the scoring guidelines given in row 410 of table 400, a numerical scoring value is assigned to each project for each sub-criteria. For example, for the privacy program, the alignment to strategy sub-criteria of business alignment is assigned a numerical scoring value of “8” because alignment to strategy was ranked high during consideration of how the privacy program advances or interferes with the organizational strategy.

At step 316, the method 300 further includes aggregating the scores for each project across the sub-criteria to determine a summary rating score for each project and assigning a rank to each project based on the summary rating score at step 320. For example, as shown in column 412 of table 400, the privacy program scores are aggregated to equal 490, the harassment program scores are aggregated to equal 475, the KYC program scores are aggregated to equal 631, the AML consent order scores are aggregated to equal 485, the Project X scores are aggregated to equal 485, and the Risk Reporting FMK scores are aggregated to equal 359. The programs are then ranked with the highest scoring program being assigned the highest ranking and the lowest scoring program being assigned the lowest ranking, as shown in column 414.

It should be noted that scoring may be performed via a variety of suitable methods, depending on implementation-specific considerations. For example, in some embodiments, scoring may be provided via human input. In other embodiments, scoring may be provided via automated calculations based on the business rules in the criteria guidelines for ingested risk-related meta-data, or automated calculations based on the business rules in the criteria guidelines for meta-data maintained at the work stream level within each project.

The method 300 may further include adapting the assigned rank of each of the projects with an override capability based on project dependencies and/or prerequisites, at step 322. For example, in some embodiments, the assigned ranking may be adjusted, for instance, because a given project depends on the completion of another project not yet completed. The method 300 may further include applying an available budget against the ranked projects to determine which projects to pursue, at step 324. For example, in accordance with the method 300 the projects may be pursued in the order from highest to lowest ranked until the budget for a given time period (e.g., a given fiscal year or quarter) is exhausted. In other embodiments, a costly but higher ranked project may be put on hold to complete a larger number of lower ranked projects.

The method may further include incrementally aggregating capital and operating costs of each project in an order of descending ranks until the aggregated costs of the plurality of projects are accommodated by an available project funding in an applicable fiscal period, via the one or more hardware processors.

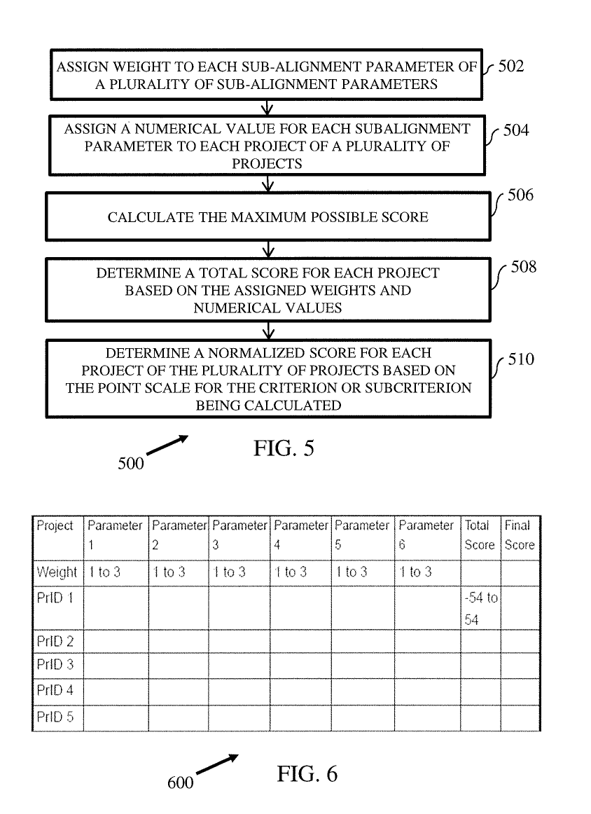

FIG. 5 illustrates an exemplary method 500 for determining a score for each of the sub-criteria (i.e., strategy and values) under the business alignment criterion to compare to the guidelines provided, for example, in row 410 of table 400. The method 500 will be explained in detail below with reference to a table 600 configured to be completed in accordance with method 500.

The method 500 includes assigning a weight to each sub-alignment parameter of a plurality of sub-alignment parameters at step 502. For example, the sub-alignment parameters may be defined by parameters 1-6 shown in row 602 of table 600. The sub-alignment parameters may then be defined by parameters 1-6 in the form of strategies 1-6 or values 1-6. It may be recognized that each of parameters 1-6 may not be of equal importance to an organization. Therefore, in row 604 of table 600, a weight between 1 and 3 is assigned to each of parameters 1-6 to be used as a multiplying value (representing an alternative approach for weighting to either percentages or total point values as described above for method 300).

For example, if the parameters 1-6 correspond to strategies 1-6, a value between 1 and 3 may be assigned based on the relative importance of a given strategy to the organization. The strategies for table 600 may be sourced from the statement of business objectives and strategies found, for example, in enterprise planning documentation, metrics documentation, and/or annual report statements. In an embodiment, the system 300 may utilize text mining techniques or intelligent text analysis to extract relevant information from enterprise planning documentation, metrics documentation, and/or annual report statements, and for deriving the scores to be assigned to the parameters 1-6 based on the relevant information.

Further, in assigning the value between 1 and 3, a sliding scale may be implemented to account for the fact that a given project may be integral to a single business strategy or relevant to many business strategies. For further example, if the parameters 1-6 correspond to values 1-6, a value between 1 and 3 may be assigned based on the relative importance of a given value to the organization. The values for table 600 may be sourced from the statement of the organization's ethical values, corporate social responsibility report, and/or code of conduct. Further, in assigning the value between 1 and 3, a sliding scale may be implemented to account for the fact that a given project may be integral to a single organizational value or relevant to many corporate values.

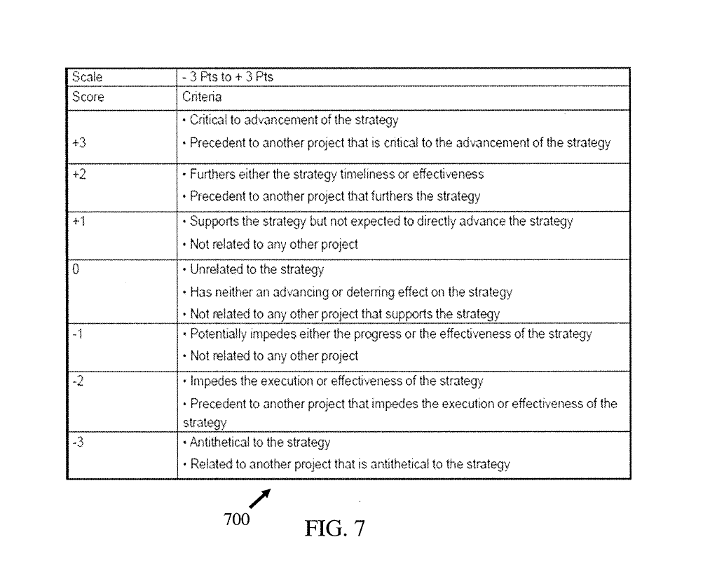

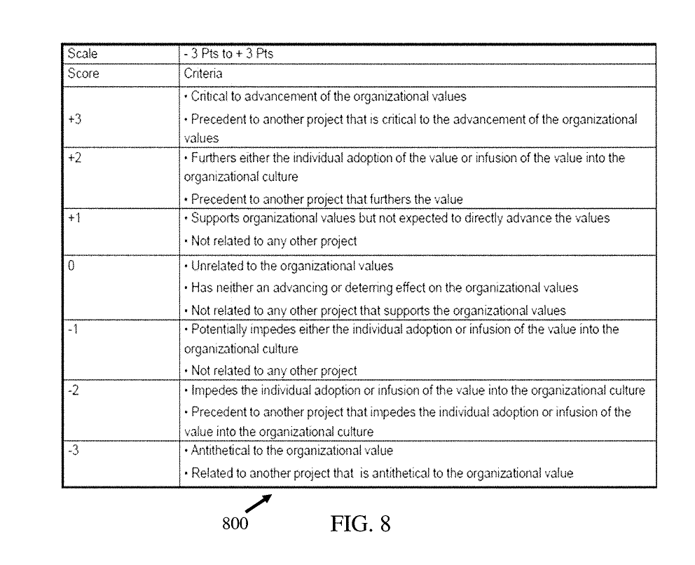

The method 500 further includes assigning a numerical value for each sub-alignment parameter to each project of a plurality of projects at step 504. For example, for a plurality of projects 606, each project is assigned a value between −3 and +3 for each of the parameters (e.g., strategies or values) in row 602. In some embodiments the values between −3 and 3 may be assigned in accordance with table 700 shown in FIG. 7 for strategies, or table 800 shown in FIG. 8 for values. It is recognized that current systems for project portfolio prioritization may not support negative number point scales, and the algorithm for the methodology may be adjusted accordingly to support solely positive numbers, translating the calculations to have the desired impact of making the pursuit of compliance projects that are detrimental to strategy or values less attractive.

Referring now to FIG. 7, an exemplar set of criteria for assigning an alignment to strategy score is illustrated in table 700. As shown in the table 700 of FIG. 7, if the parameters 1-6 are strategies 1-6, a “3” may be assigned if the project is critical to the advancement of the strategy and/or is precedent to another project that is critical to the advancement of the strategy. A “2” may be assigned if the project furthers the strategy timeliness and/or effectiveness, and/or if the project is precedent to another project that furthers the strategy timeliness and/or effectiveness. A “1” may be assigned if the project supports the strategy but is not expected to directly advance the strategy and/or if the project is a standalone project not related to other projects relevant to the strategy. A “0” may be assigned if the project is unrelated to the strategy, has neither an advancing no a deterring effect on the strategy, and/or is not related to any other project that supports the strategy. A “−1” may be assigned if the project potentially impedes either the progress or the effectiveness of the strategy and/or is not related to any other project. A “−2” may be assigned if the project impedes the execution or effectiveness of the strategy and/or is precedent to another project that impedes the execution and/or effectiveness of the strategy. A “−3” may be assigned if the project is antithetical to the strategy and/or if the project is related to another project that is antithetical to the strategy. In this way, a value between −3 and 3 may be assigned based on the projects' overall alignment with the strategies that are important to an organization.

Referring now to FIG. 8, an exemplar set of criteria for assigning an alignment to values score is illustrated in form of a table 800. As shown in the table 800 of FIG. 8, if the parameters 1-6 are values 1-6, a “3” may be assigned if the project is critical to the advancement of the organizational values and/or is precedent to another project that is critical to the advancement of the organizational values. A “2” may be assigned if the project furthers either the individual adoption of the value or the infusion of the value into the organizational culture and/or if the project is precedent to another project that furthers the value. A “1” may be assigned if the project supports the organizational values but is not expected to directly advance the value and/or if the project is unrelated to any other project relevant to the value. A “0” may be assigned if the project is unrelated to the organizational value, has neither an advancing nor deterring effect on the organizational values, and/or is not related to any other project that supports the organizational values. A “−1” may be assigned if the project potentially impedes either the individual adoption of the value or the infusion of the value into the organizational culture and/or is not related to any other project. A “−2” may be assigned if the project impedes the individual adoption of the value or the infusion of the value into the organizational culture and/or is precedent to another project that impedes the individual adoption of the value or the infusion of the value into the organizational culture. A “−3” may be assigned if the project is antithetical to the organizational value and/or is related to another project that is antithetical to the organizational value. In this way, a value between −3 and 3 may be assigned based on the projects' overall alignment with the values that are important to an organization.

Returning to method 500, once the numerical value has been assigned to each project for each sub-alignment parameter, a maximum possible score is calculated, at step 506. For example, the maximum possible score is calculated for table 600 by multiplying 9 times the number of parameters 1-6 for a total maximum possible score of 602 (and minimum possible score of −54). A total score for each project of the plurality of projects 606 may then be determined based on the assigned weights for each of parameters 1-6 in row 604 and the assigned numerical values (block 48). For example, the total score for each project may be determined by multiplying the assigned numerical values by the assigned weights for each of parameters 1-6. It should be noted that in some embodiments, the total score may be summed to ensure that it is less than or equal to a predetermined category value.

The method 500 further includes determining a normalized score for each project, at step 510. For example, a negative to zero score may be set to zero. To determine the non-zero final scores, the final score may be equal to [(total score for the project)*(criterion value [410])]/(maximum score)]. In this way, a final, normalized score may be determined for each project across the set of parameters (e.g., strategies or values), and the normalized score may be representative of the alignment of each project with selected strategies and/or values. Further, the normalized scores may be used to determine the numerical values to be assigned to the strategy and values columns of the alignment portion of table 500 shown in FIG. 6.

In order to determine the numerical values that will be assigned to the project risk impact portion of the table 600 of FIG. 6, an evaluative analysis may be undertaken for the change management and readiness columns, as described in more detail below. However, for the scope and complexity columns of the project risk impact portion of the table 600, an output from a GRC analytics for competitive edge program may be used to assign the scores in accordance with row 410. For example, in one embodiment, the outputs may be received from the GRC analytics for competitive edge program as defined in co-pending application entitled, “Systems and Methods for Governance, Risk, and Compliance Analytics for Competitive Edge,” filed concurrently herewith, which is hereby incorporated by reference in its entirety.

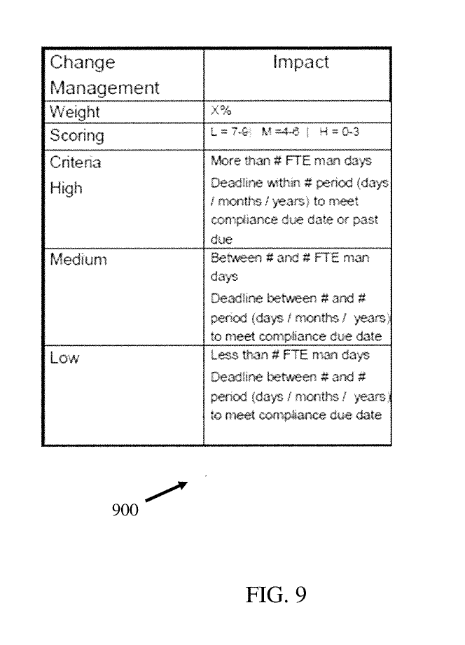

Turning now to the change management column of the project risk impact shown in table 900, each project may be evaluated in accordance with table 900 shown in FIG. 9. However, since the project risk has an inverse relationship with the likelihood of investing in a project (e.g., since a higher project risk may be associated with a lower likelihood of a successful project implementation), the scale for assigning numerical values is inverted. That is, a lower project risk will be associated with a higher score.

As illustrated in FIG. 9, an exemplar set of criteria to be generated algorithmically from the aggregation and analysis of reference data across multiple individual work streams within the project for assigning a project change management rating, is provided in accordance with some embodiments of the present disclosure. The change management table 900 provides a method for determining a rating of the level of effort aggregated across all work streams within the project and the proximity of the compliance due date. To that end, as shown in table 900, a project will be assigned a high rating if it exceeds a predetermined threshold number of full time equivalent (FTE) man days and/or if the deadline for completion of the project is within a predetermined threshold amount of time. Further, a project will be assigned a medium rating if it is within a predetermined range of FTE man days and/or the deadline for completion of the project is within a predetermined range of time. Likewise, a project will be assigned a low rating if it is below a predetermined threshold number of FTE man days and/or the deadline is within a second predetermined range of time. The predetermined thresholds and ranges may be provided by a user, for example, via a user interface. Once a rating of high, medium, or low has been assigned, this rating may be compared to the scoring in row 410 of table 400 to determine the numerical values inserted in the change management column of the project risk impact portion of table 400. Alternatively, since man days and milestones or deadlines are typical meta-data maintained regarding each project, a further optimized embodiment would leverage this meta-data to automatically calculate the rating, with more refined parameters for each available point within the range for the rating.

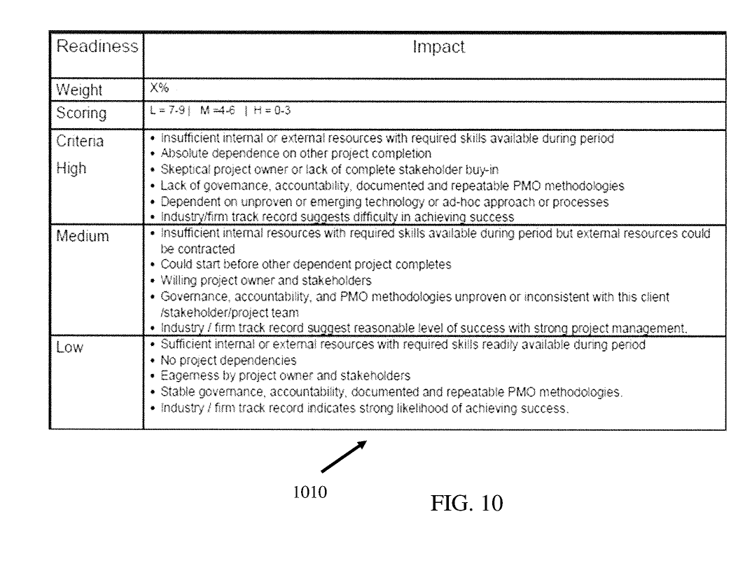

Turning now to the project readiness column of the project risk impact shown in table 400, each project may be evaluated in accordance with table 1000 shown in FIG. 10. The project readiness table 1000 provides a method for determining a rating of the degree to which the organization's capabilities are sufficiently mature to implement the project. In particular, FIG. 10 illustrates an exemplar set of criteria for assigning a project readiness rating, in accordance with some embodiments of the present disclosure. To that end, as shown in table 1000, a high rating may be assigned if there are insufficient internal or external resources with the required skills available during the time period of the project. A high rating may also be assigned if the completion of the project is absolutely dependent on the completion of another project. A skeptical project owner or lack of complete stakeholder buy-in may also support a high rating. A documented and/or repeated lack of governance or accountability may also support a high rating. Further, if the project is dependent on an unproven or emerging technology or an adhoc approach or process, a high rating may be supported. Additionally, a high rating may be selected when the industry or firm track record suggests there will be difficulty in achieving success.

A medium rating may be assigned if there are insufficient internal resources with the required skills available during the time period of the project, but external resources could be acquired via contract. A medium rating may also be assigned if the project could start before another project upon which it depends is completed and/or if the project owner and stakeholders are supportive of the project. A medium rating is also supported if the governance, accountability, and project management methodologies are unproven or inconsistent with a client, stakeholder, or team associated with the project. A medium rating may also be assigned if the industry and/or firm track record suggests a reasonable level of success and strong project management.

A low rating may be assigned if there are sufficient internal or external resources with the required skills readily available during the time period of the project. A low rating may also be assigned if there are no project dependencies and there is eagerness shown by the project owner and stakeholders. A low rating may also be supported by stable governance, accountability, and documented and repeatable project management methodologies. A low rating may also be assigned if the industry and/or firm track record indicates a strong likelihood of achieving success. Once a rating of high, medium, or low has been assigned for readiness for each project, this rating may be compared to the scoring in row 410 of table 400 to determine the numerical values inserted in the readiness column of the project risk impact portion of table 400.

An embodiment of the system may also include an algorithmic analysis of whether the majority of selected guidance falls within a particular point range and determine an “average rating” across all criteria. For example, if the criterion is characterized as meeting 3 out of 5 guidelines in the Medium range while matching 2 guidelines in the high range, then an “averaging” would keep the scoring to the larger points in the Medium range. Alternatively, an embodiment of the system using the same example data, may include an algorithmic analysis that solely looks at the fact that 2 guidelines are met in the high range out of 5 guidelines and thereby assigns a point value on the lower end of the point range for the high rating.

Turning now to the GRC risk management portion of table 400 embodiments of methods for determining the health and safety, financial, and reputational rating are discussed in more detail below. However, for the compliance column of the GRC risk management impacts portion of the table 400, an output from a GRC analytics for competitive edge program may be used to assign the scores in accordance with row 410. For example, in one embodiment, the outputs may be received from the GRC analytics for competitive edge program as defined in co-pending application (U.S. provisional application No. 62/253,877) entitled, “Systems and Methods for Governance, Risk, and Compliance Analytics for Competitive Edge,” filed concurrently herewith.

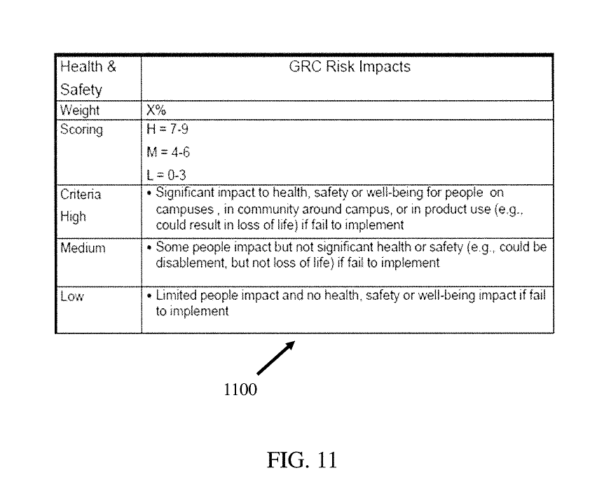

FIG. 11 illustrates an exemplar set of criteria in form of a table 1100 outlining a method for assigning a rating to be used in determining the numerical value in the health and safety risk column of the GRC risk management impacts portion of table 400. The project rating for health and safety corresponds to the prospective impact of the project on the health, safety, and welfare of individuals on firm campuses or a part of the community where the campuses are located if the project is not undertaken or a compliance failure occurs. As shown in table 1100, a high rating may be assigned if the project is predicted to have a significant impact on the health, safety, or well-being of the people on firm campuses or in the community surrounding the firm campus. A high rating may also be assigned if failure to implement the project could result in loss of life. A medium rating may be assigned if some portion of individuals on the firm campus or in the surrounding area of the firm campus will experience some impact from failure to implement the project, but the impact does not significantly impact such people (e.g., failure to implement the project may cause disablement, but not loss of life or limb). A low rating may be assigned if a limited number of people will be impacted by the failure to implement the project and/or there is not a safety or well-being impact if the project is not implemented. Here again, once the rating is assigned to each project for health and safety, this rating is converted to the numerical scale shown in row 410 of table 400 and inserted in the health and safety column of table 400 for each project.

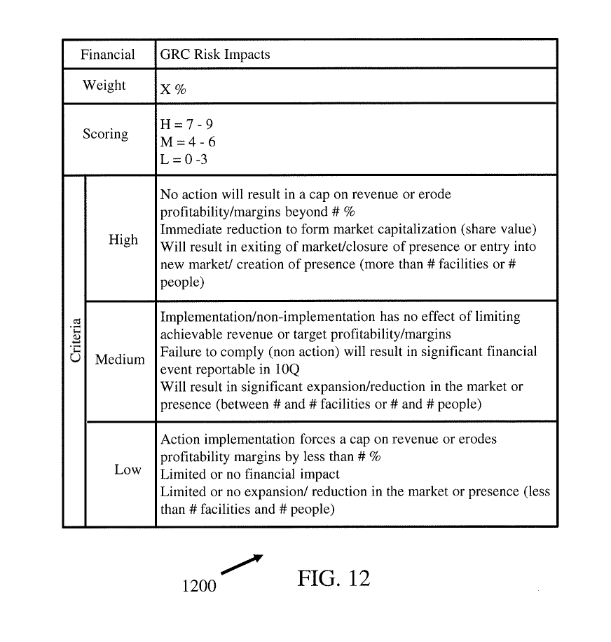

FIG. 12 illustrates an exemplar set of criteria in form of a table 1200 outlining a method for assigning a rating to be used in determining the numerical value in the financial risk column of the GRC risk management impacts portion of table 400. The project rating for financial risk impacts corresponds to the prospective impact of the project on financial measures (e.g., those not related to the project and implementation costs) relative to the physical presence (e.g., facilities and operations), as well as products and revenues. As shown in table 1200, a high rating may be assigned if failing to implement the project is expected to result in a cap on revenue or erode profitability and/or margins beyond a predetermined threshold. A high rating may also be assigned if project implementation will result in an immediate reduction to firm market capitalization (e.g., share value). Similarly, a high rating would be warranted if the project represented a wholesale change in market presence through entering or exiting a market, with a threshold of number of facilities to be opened/closed, or people to be displaced (laid off) or hired.

A medium rating may be assigned if the project implementation or non-implementation is expected to have no effect of limiting achievable revenue or target profitability and/or margins. A medium rating may also be assigned if failure to comply with the compliance mandate will result in a significant financial event that must be reported in the organization's 10Q. A medium rating may also be assigned if project implementation is expected to result in significant expansion or reduction in the market or presence.

A low rating may be assigned if project implementation forces a cap on revenue or erodes profitability and/or margins by less than a predetermined percent. A low rating may also be assigned if project implementation is expected to have a limited or no financial impact. A low rating may also be assigned if project implementation is expected to have limited or no expansion or reduction in the market, or presence.

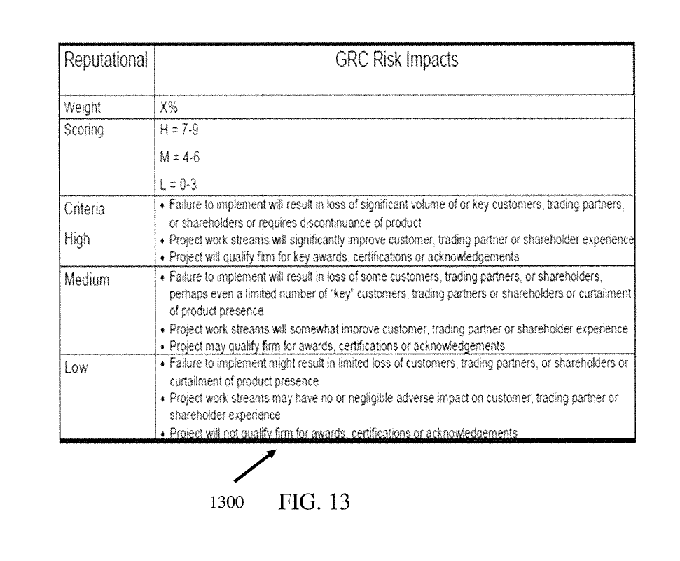

FIG. 13 illustrates an exemplar set of criteria in form of a table 1300 outlining a method for assigning a rating to be used in determining the numerical value in the reputational risk column of the GRC risk management impacts portion of table 400. The project rating for the reputational component corresponds to the assessment of the likelihood and degree of impact if a failure in compliance is revealed to shareholders, business partners, employees, existing or prospective customers, and/or the public at large. As shown in table 1300, a high rating may be assigned if the failure to implement the project is expected to result in loss of significant volume of key customers, trading partners, or shareholders, or requires discontinuance of a product. A high rating may also be assigned if project work streams are expected to significantly improve customer, trading partner, or shareholder experience. A high rating may also be assigned if the project is expected to qualify the organization for key awards, certifications, or acknowledgements.

Likewise, a medium rating may be assigned if the failure to implement the project is expected to result in loss of some customers, trading partners, or shareholders, or even a limited number of “key” customers, trading partners or shareholders, or curtailment of product presence. A medium rating may also be assigned if the project work streams are expected to somewhat improve customer, trading partner, or shareholder experience and/or if undertaking the project may qualify firm for awards, certifications, or acknowledgements.

Similarly, a low rating may be applied if the failure to implement the project might result in a limited loss of customers, trading partners, or shareholders, or curtailment of product presence. A low rating may also be applied if the project work streams may have no or a negligible adverse impact on customer, trading partner or shareholder experience. A low rating may also be applied if the project is not expected to qualify the organization for awards, certifications, or acknowledgements.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

Various embodiments present method and system for ranking projects in a portfolio of projects in order to prioritize projects in a compliance portfolio. The disclosed system considers various evaluation criteria when assessing the priority of compliance projects, which conventional systems fail to consider. Further the system configures the relative value of each evaluation Criteria used in prioritizing compliance projects leveraging either a point scale or combination of point-scale and weighting percentage. Also, the system is capable of representing the guidance users should consider in manually assigning rating points to individual evaluation criteria, and computes automated point-scale values for Evaluation Criteria tied to Dimension meta-data. The system computes evaluation criteria determined based on nature of and risk-relevant meta-data associated with individual project work stream nodes. Also, the system captures and re-computes raw score/rank order based on overrides and project dependencies to preserve overrides during continuous reprioritization processes. The system provides an efficient way of prioritizing the projects since it uses data that is imported rather than requesting new assessment values or manual re-entry of existing values. Further, the system anticipates use of a toolset in a continuous reprioritization process as new projects are identified rather than solely fixed timeline/scheduled prioritizations in advance of specific budget cycles. Furthermore, the system undertakes iterations before finalizing the ranking of the projects.

It is intended that the disclosure and examples be considered as exemplary only, with a true scope and spirit of disclosed embodiments being indicated by the following claims.

What is claimed is:

1. A processor-implemented method for ranking projects in a portfolio of projects, comprising:
assigning relative weights to a set of criteria and a set of sub-criteria associated with the set of criteria for rating a plurality of projects in the portfolio of projects, via one or more hardware processors;
assigning numerical scoring values to a plurality of guideline scoring ranges for each of the set of criteria and the set of sub-criteria for prioritizing a plurality of projects, via the one or more hardware processors;
assigning a numerical scoring value to each of the plurality of projects for each of the set of sub-criteria, via the one or more hardware processors;
aggregating the numerical scoring values for each project in the portfolio of projects across the set of sub-criteria to obtain a summary rating score for each project, via the one or more hardware processors;
assigning a rank to each of the plurality of projects based on the summary rating score for each project to obtain a plurality of ranks, via the one or more hardware processors;
adapting the plurality of ranks of the plurality of projects based on a project data associated with the plurality of projects, via the one or more hardware processors, the project data indicative of project dependencies and pre-requisites; and
incrementally aggregating capital and operating costs of each project in an order of descending ranks of the plurality of ranks until the aggregated costs of the plurality of projects are accommodated by an available project funding in an applicable fiscal period, via the one or more hardware processors.

2. The method of claim 1, wherein the plurality of criteria comprises business alignment, project risk management impact, governance, risk, and compliance (GRC) risk management impact, and value.

3. The method of claim 2, wherein the set of sub-criteria associated with the set of criteria comprises:
sub-criteria alignment to strategies and values associated with the criteria alignment;
sub-criteria scope, change management, complexity, and readiness associated with the criteria project risk management, and
sub-criteria health and safety risk, financial risk, reputational risk, and compliance risk associated with the criteria GRC risk management.

4. The method of claim 1, wherein assigning the relative weights further comprises normalizing weights assigned to each of the plurality of sub-criteria to match a predetermined range of weight associated with each of the plurality of sub-criteria.

5. A system for ranking projects in a portfolio of projects, the system comprising:
one or more memories; and
one or more hardware processors, the one or more memories coupled to the one or more hardware processors, wherein the one or more hardware processors are capable of executing programmed instructions stored in the one or more memories to:
assign relative weights to a set of criteria and a set of sub-criteria associated with the set of criteria for rating a plurality of projects in the portfolio of projects;
assign numerical scoring values to a plurality of guideline scoring ranges for each of the set of criteria and the set of sub-criteria for prioritizing a plurality of projects;
assign a numerical scoring value to each of the plurality of projects for each of the set of sub-criteria;
aggregate the numerical scoring values for each project in the portfolio of projects across the set of sub-criteria to obtain a summary rating score for each project;
assign a rank to each of the plurality of projects based on the summary rating score for each project to obtain a plurality of ranks;
adapt the plurality of ranks of the plurality of projects based on a project data associated with the plurality of projects, the project data indicative of project dependencies and pre-requisites; and
incrementally aggregate capital and operating costs of each project in an order of descending ranks of the plurality of ranks until the aggregated costs of the plurality of projects are accommodated by an available project funding in an applicable fiscal period.

6. The system of claim 5, wherein the plurality of criteria comprises business alignment, project risk management impact, governance, risk, and compliance (GRC) risk management impact, and value.

7. The system of claim 6, wherein the set of sub-criteria associated with the set of criteria comprises:
sub-criteria alignment to strategies and values associated with the criteria alignment;
sub-criteria scope, change management, complexity, and readiness associated with the criteria project risk management, and
sub-criteria health and safety risk, financial risk, reputational risk, and compliance risk associated with the criteria GRC risk management.

8. The system of claim 5, wherein to assign the relative weights, the one or more hardware processors are capable of executing programmed instructions to normalize weights assigned to each of the plurality of sub-criteria to match a predetermined range of weight associated with each of the plurality of sub-criteria.

9. A non-transitory computer-readable medium having embodied thereon a computer program for executing a method for ranking projects in a portfolio of projects, the method comprising:
assigning relative weights to a set of criteria and a set of sub-criteria associated with the set of criteria for rating a plurality of projects in the portfolio of projects;
assigning numerical scoring values to a plurality of guideline scoring ranges for each of the set of criteria and the set of sub-criteria for prioritizing a plurality of projects;
assigning a numerical scoring value to each of the plurality of projects for each of the set of sub-criteria;
aggregating the numerical scoring values for each project in the portfolio of projects across the set of sub-criteria to obtain a summary rating score for each project;
assigning a rank to each of the plurality of projects based on the summary rating score for each project to obtain a plurality of ranks;
adapting the plurality of ranks of the plurality of projects based on a project data associated with the plurality of projects, the project data indicative of project dependencies and pre-requisites; and
incrementally aggregating capital and operating costs of each project in an order of descending ranks of the plurality of ranks until the aggregated costs of the plurality of projects are accommodated by an available project funding in an applicable fiscal period.
